(19) United States
(12) Patent Application Publication
(10) Pub. No.: US 2022/0108308 A1
(43) Pub. Date: Apr. 7, 2022

(54) TRANSPORTATION, STORAGE AND SERVICE FUTURES

(71) Applicant: TRUCKL LLC, Dallas, TX (US)

(72) Inventor: Hanns-Christian Leemon Hanebeck, Dallas, TX (US)

(21) Appl. No.: 17/311,668

(22) PCT Filed: Dec. 9, 2019
(86) PCT No.: PCT/US19/65297

§ 371 Date: Jun. 7, 2021

Related U.S. Application Data
(60) Provisional application No. 62/778,283, filed on Dec. 11, 2018.

(51) Int. Cl. G06Q 20/38; G06Q 20/02; G06Q 20/40; G06Q 40/06; G06Q 10/08

(52) U.S. Cl. CPC G06Q 20/389; G06Q 20/02; G06Q 10/083; G06Q 40/06; G06Q 20/4014

(57) ABSTRACT

Methods and systems for the creation, validation and trading of transportation, storage or service capacity through future financial instruments, the use of explicit legal futures agreements, the application of insurance contracts to futures, the application of factoring or another form of financing to pay for futures at the time of purchase or fulfillment, the monitoring of futures contract execution and the establishment of futures default contingencies are provided.

### BACKGROUND

The inventor of the present invention has recognized problems unaddressed in the art regarding the sale and purchase (“trading”) of future transportation, warehouse storage or service provision capacity. Transportation, storage and service markets are highly opaque and reactive today. For example, the sale and purchase of transportation services is predominantly focused on the fulfillment of capacity that is needed immediately, or within a few days ahead of schedule and there is no open market or trading platform today where many buyers and sellers come together to trade future transportation capacity. Likewise, the trading of warehouse storage capacity is largely limited to long-term contracts and often based on established vendor-customer relationships rather than accessible on an open market with a large number of independent buyers and sellers trading future warehouse storage capacity through financial instruments and legally binding contracts. The same holds true for the trading of supply chain and logistics services such as call center operations, demand planning services, manufacturing and kitting services or resource augmentation and staffing services.

Further, for most transportation, storage and service market participants including, but not limited to, buyers, sellers, intermediaries and middlemen, it is impossible to predict future transportation, storage and services demand due to a lack of information sharing between all parties. For example, a manufacturer may know when and where they need transportation, storage or services capacity based on production plans and customer orders, distribution patterns or market behavior. Yet, this information is seldom, if ever, shared with other parties. Similarly, transportation, storage or services capacity providers may know what future capacity and resource utilization might look like based on asset inventory, planned asset purchases, human resource and staffing plans, economic forecasts and so on. Yet, this data is seldom shared with other parties as well. Intermediaries or middlemen such as freight forwarders, brokers or dispatchers often have no information about future capacity demand or future capacity supply at all. Today, all parties often simply react when a new load needs to be tendered or when warehouse storage or services capacity needs to be procured. The market for future transportation, storage or service capacity is highly opaque and characterized by a lack of communication between all parties.

In addition, it is not possible today to trade future transportation, storage or service capacity in the same manner in which financial instruments such as commodity contracts or options are sold and purchased. For example, for large shippers and carriers it may be possible to lock down access to future transportation capacity through long-term contracts with specific providers, but these contracts are usually inflexible and cannot be traded freely. In addition, this option is certainly not available to the majority of smaller market participants. Further, a market platform where transportation, storage or service capacity could be advertised for sale and purchased for future use does not exist today. Subsequently, transportation, storage or service capacity as well as adjacent services cannot be efficiently traded today.

Part of the problem today is that it is hard to hold transportation, storage or service capacity providers to commitments they may make about future services. When a typical commodity such as gold, pig bellies or corn is traded, there is a physical good that exists. If transportation, storage or service capacity were to be traded, there would just be a promise of fulfillment unless legally binding contracts are executed. However, there are no specific legal instruments available today that can help to alleviate this problem and there is little in terms of contractual enforcement on all sides of a transaction, which requires the ability to hold all parties accountable to promises made in regard to future transportation, storage or service provision among other things. Likewise, there is no information available today on the historical performance of individual transportation, storage or service capacity providers in regard to their performance on executed futures contracts given that these instruments do not yet exist. Even if they existed today, there are no processes or technology tools available today that can determine how well individual market participants execute on their promises of future performance.

Further, there are no methods, processes, systems or technology tools available today that allow the trading of future transportation, storage or service capacity financial instruments (“futures”) after they have been created and before they are due and there is no marketplace where such futures could be advertised for sale or located for purchase. For example, it is not possible for a buyer to purchase transportation, storage or service futures and to then sell them before their call dates to another buyer or to exchange them for different contracts before their call dates. Similarly, there is no ability to bundle multiple transportation, storage or service futures together into a single futures product that can then be traded as one unit and potentially be collateralized. Likewise, there is no marketplace or trading platform available today that allows the advertisement of transportation, storage or service futures in a transparent way so that prices of future transportation, storage or service capacity could be efficiently set through market supply and demand. Similarly, there are no processes or technology tools available today that allow dynamic pricing of future transportation, storage or service capacity based on additional factors that include, but are not limited to, (a) proximity to a call date, (b) increasing or decreasing popularity of lanes or origin and destination pairings or locations, (c) current or future levels of fuel and other resource prices or personnel cost, or (d) larger economic factors, social and societal developments or general industry trends.

Still further, there are no methods, processes, systems or technology tools available today that allow buyers of future transportation capacity to purchase a transportation future based on a set origin point, which may be independent of a destination point. Likewise, it is not possible today to purchase a transportation future independent of an origin point, but with a fixed destination. Further, it is not possible today to purchase a number of miles driven independent of a predetermined origin or destination points in a transportation future. Still further, there is no ability to purchase a transportation future that is based on hours driven with a fixed origin, a fixed destination or neither. Still further, it is not possible to purchase a transportation future for local markets e.g. within a predefined perimeter of a zone such as a zip code or a major metropolitan area based on miles driven or hours driven or both.

Still further, there are no methods, processes, systems or technology tools available today that would allow the consolidation of several shipments or transactions into a single transportation future. For example, a buyer of a transportation future may only need eight pallet spaces of capacity, which may leave as much as another ten available on a typical 40 ft trailer that has been committed to move from a specific origin to a specific destination at a future date. Today, a buyer typically does not have the ability to independently sell the remaining capacity on the asset as one or more additional futures contracts on a trading platform. Neither does the buyer have the ability to lock down the entire load to then sell excess capacity on the asset in question on his own account and possibly for a profit on a trading platform. Neither does the seller have the ability to consolidate multiple loads into a single shipment based on a multitude of independent transportation futures.

Still further, in transportation, there exists a special problem that carriers often drive away from their home base to deliver a specific load, but then have to return to their base empty. If the location of the transportation asset at its future destination is known, there are no methods, processes, systems or technology tools available today that allow the carrier to sell additional transportation futures on a trading platform that would allow him to return to his base with a second load to generate additional revenues.

Still further, there are no methods, processes, systems or technology tools available today that allow buyers of future transportation, storage or service capacity to ensure their futures are backfilled when a contracted capacity provider defaults. Likewise, there are no methods, processes, systems or software tools available today that allow buyers and sellers of future transportation, storage or service capacity to monitor that futures are executed correctly or that they will be executed according to specific contractual terms when they become due.

Still further, there are no instruments available today to insure contracts for future transportation or storage capacity, which could possibly alleviate issues around trust between market participants. There are no dedicated insurance products available to insure against defaults on transportation, storage or service futures, for example, or to insure capacity providers against shippers who may default on utilizing contracted capacity. Likewise, it is not possible today to reinsure futures contracts that have been insured.

Still further, there currently are no financing offerings such as factoring or other forms of payment available for future transportation, storage or service capacity trades. Factoring is a process by which transportation carriers, for example, are paid instantly when they deliver a load while the factoring business then collects the payment of the original invoice from the shipper when it is due and charges the carrier a percentage fee. Other forms of financing work similarly in that a third-party may pay for a future and charge the buyer of the future at a later point in time. A factoring business, for example, cannot pay for a future transportation contract today to then charge the buyer at the time of pickup or delivery for the initial payment along with a transaction or interest fee. Likewise, a factoring business is not able to bundle more than one future into a product that can be independently purchased or sold. Today, there are no factoring or other forms of financing instruments available that allow buyers and sellers of future transportation, storage or service capacity to finance an option on that capacity.

Moreover, today it is not possible to trade futures for semi-autonomous or autonomously operated material moving assets including, but not limited to, autonomous transportation vehicles or vans, autonomous delivery drones, or autonomous passenger vehicles that may transport freight for short or long distances. Owners and operators of autonomous vehicles do not have the ability to offer their capacity for sale in a futures market and sellers do not have the ability to purchase that capacity.

Further, today it is not possible to leverage distributed ledger technology such as Blockchain or Hashgraph to document the purchase, sale, trading or fulfillment of transportation, storage or service futures.

### SUMMARY OF THE INVENTION

These and other problems in the art are overcome by methods and systems for the creation, validation and trading of transportation, storage or service capacity through future financial instruments (“futures”), the use of explicit legal futures agreements, the application of insurance contracts to futures, the application of factoring or another form of financing to pay for futures at the time of purchase or fulfillment, the monitoring of futures contract execution or the establishment of futures default contingencies. From here on after, financial and legal instruments that represent an option or contract for the fulfillment of future transportation, warehouse storage or service capacity use and that allow the trading of these instruments will be referred to as “futures” for the purposes of this invention disclosure.

Transportation constitutes the planning and execution of the movement of materials by a transportation asset that may include, but is not limited to, a vehicle such as a truck or van, a container or trailer, a railroad, an airplane, a helicopter, a drone, a pipeline, a ship or a barge. Transportation assets may be operated by a human operator, semi-autonomously or autonomously.

Storage or warehousing constitutes the storage of materials for a period of time in a given location. Storage assets may include, but are not limited to, physical facilities intended for material storage, physical facilities not intended for the storage of materials or moving assets such as a transportation asset. Equipment used in storage and warehousing may include, but is not limited to, forklifts, storage racks, conveyor belts, drones or pallet jacks. Storage assets may be operated by a human operator, semi-autonomously or autonomously. Storage or warehouse capacity may be traded as futures in the same manner as transportation capacity.

Supply chain services may include, but are not limited to, call center operations, information technology provision, demand or supply chain planning services, maintenance and repair work, resource and staff augmentation, supply chain outsourcing services, kitting and assembly services, packaging or repackaging, contract manufacturing services, freight brokerage, freight forwarding, or dispatch services. Services may be performed by human operators, semi-autonomously or autonomously. Supply chain services may be traded as futures in the same manner as transportation and warehouse storage capacity.

Transportation, storage and service capacity may be traded just like many other goods through the establishment of a futures market allowing buyers and sellers to obtain futures in exchange for payments or in barter for other futures. From here on after, a market that allows buyers and sellers of transportation, storage or service futures will be referred to as “futures market” and the methods, processes, systems and technology tools that enable a futures market will be referred to as “trading platform” for the purposes of this invention disclosure. A futures market and trading platform requires that all participants have visibility into the availability of futures supply and demand, that futures prices are established clearly, for example through supply and demand or by an authorized third-party entity, that futures can be traded, that they can be resold once purchased, that they can be spilt into smaller units than the ones agreed to on the initial futures contract e.g. that individual truck loads on a multi-load futures may then be resold separately, that buyers and sellers can be insured against defaults, that futures can be financed through factoring or another form of financing, that all futures are clearly defined in terms of performance criteria and through a specific call date, the day or period of time when a specific future will be used, and that there are methods, processes, systems and technology tools available to monitor the execution of futures contracts or to establish the position of backhaul freight capacity to fulfill a futures contract. A futures market and trading platform should also allow for the sale of futures from one buyer to another and from one seller to another or from a first buyer to another seller.

One of the benefits of a futures market is that it allows for the publication of information about supply and demand by many different parties on a single trading platform or on a network of connected trading platforms. Similar to a stock market, buyers and sellers can advertise their needs and offerings and can bid on futures while prices of similar futures may adjust according to market demand. For example, a transportation lane from New Orleans to Chicago may trade at a certain price for a specific material and transportation asset such as a dry van trailer or tanker truck. Prices may be displayed in units that include, but are not limited to, cost per mile, cost per segment, cost per square foot, cost per pallet, cost per unit of time, cost per transaction, or the cost of a futures contract. Prices may vary and change over time. Transportation, storage and service capacity pricing may be influenced by a number of factors including, but not limited to, origin and destination pairings, closeness to a call date, popularity of lanes, fuel and other resource cost, availability of personnel, economic outlook, or industry trends.

A futures market and trading platform may also allow for the publication of recent and past futures trades and for the overlay of correlated information including, but not limited to, overall economic outlook, seasonality or demand for materials being transported and stored or service being performed. Buyers and sellers may specialize in the trading of specific types of futures, they may specialize in aggregating futures into larger bundles or the mixing of different types of futures into packages. Some buyers and sellers may specialize in creating custom tailored futures packages for a specific project or a specific customer. Buyers and sellers may also specialize in the trading of futures for an industry or group of similar industries. In some cases, buyers and sellers may be supply chain industry professionals, financial professionals or specialized brokers and in other cases, they may be speculators who trade futures as they would any other funds, options or stocks.

It is further possible that a futures market and trading platform allows for the creation of indices including, but not limited to, industry-focused indices, indices for different types of futures or indices with a focus on seasons or geographies that may be traded separately from specific transportation, storage or service futures. Indices may also be used to aggregate focused futures purchases into exchange traded funds that can be traded separate from individual futures contracts. Further, it is possible that a futures market allows for the trading of calls and puts based on the future price of futures contracts allowing market participants or speculators to anticipate prices for specific futures to go up or down at a later point in time.

Futures may be implemented in a variety of ways that may include, but are not limited to, as an option future or as a fulfillment future. An option future allows a buyer to draw on capacity during a period of time or on a specific call date, but the buyer also has the opportunity to pass on the option to let it expire. Contrasting this, a fulfillment future binds both parties, seller and buyer, to the execution of a transportation, storage or service transaction at a price or conditions agreed-upon at the time the fulfillment future was purchased or at a later point in time. A hybrid contract, in which an option contract converts into a fulfillment contract at a certain date prior to the call date is also possible as is the inverse e.g. that a fulfillment contract may be converted into an option contract at a later point in time and before a call date. Unless explicitly stated otherwise, option, fulfillment and hybrid futures will be referred to as “futures” for the purposes of this invention disclosure.

In one embodiment of the present invention, a future may enable a buyer to take advantage of transportation, storage or service capacity at a price or conditions agreed-upon at the time the future was purchased. In another embodiment of the present invention, a future may be implemented in a way that allows the cost of the actual fulfillment, if it is chosen by the buyer, to vary based on economic factors and resource cost for example.

Futures are implemented through explicit financial and legal agreements that may include, but are not limited to, provisions that specify a call date, the day or date range when a future will or could be materially executed, conditions under which the transportation, storage or service obligation is to be fulfilled, conditions under which the future is to be paid, any other obligations for the execution of a transportation, storage or service transaction, fees to be paid to a future market, trading platform operator or futures broker, insurance and financing provisions, conditions under which agreements may be amended, changed or annulled, or penalties for defaulting on a future contract by either party. Future purchases may be executed between two or more parties automatically on a trading platform or through the purchase of a future by way of agreement between the parties involved. A hybrid form of automatic and non-automatic future purchase is possible as well.

It may be possible for a single party to be a seller and buyer of futures in the market. Further, it may be possible for a single party to sell and buy a single futures contract in a single transaction. Futures contracts may be written to a distributed ledger including, but not limited to, a Blockchain or Hashgraph. Futures contracts may be executed by way of smart contracts that may or may not be part of a distributed ledger infrastructure. A distributed ledger may be public, private or hybrid.

In any futures market, it is possible that a transportation, storage or service capacity provider defaults on the fulfillment of contractual responsibilities. Potential contractual penalties may range from monetary payments to coverage of losses and damages to contractual fines and even exclusion from the futures market or trading platform. It is further possible that futures defaults may be insured against by the buyer or seller or that a specific class of futures designed to backfill for defaulted capacity may be sold in the form of a separate futures default contract. For example, to prepare for a scenario in which a transportation provider defaults on the execution of moving materials between two cities, the future buyer may also purchase a future default contract that ensures a second provider picks up the load and moves it under the original or altered terms of the agreement. The future default contract may need to be purchased at an additional cost and allows for assurance that the specific load is moved under almost all circumstances.

It is further possible that insurers may sell policies that protect buyers of futures against defaults by covering the additional cost for a different provider to fulfill the contractual agreements at a very late notice or to cover financial or material losses. Sellers may also require protection against buyer defaults in that a buyer may not come through on the purchase of a fulfillment future. In this case, insurance policies may cover the lost revenue from the contract, especially when buyers default because they are no longer able to fulfill financial obligations or have ceased to operate as a business for example.

The types of transportation futures that may be traded include, but are not limited to, time-based, performance-based, location-based or distance-based. Time-based transportation futures may define the day and time, or date range, for the execution of a transportation contract in the future. This may include, but is not limited to, an origin and destination location and a day and time, or date range, for pickup and delivery. Performance-based transportation futures may define the end result of a transaction such as the delivery of materials from an origin to a destination location at a specific date or date range with the end-result in focus. These futures describe what needs to be have been accomplished at the end of the transaction under certain conditions. Location-based transportation futures define a specific service location for transportation providers such as a zip code, zip code range, a metropolitan area or one or more states for the operation of one or more transportation assets. Distance-based transportation futures define a number of miles as the core element of the contract which a transportation provider has to deliver on a call date. For example, a future might be defined as the purchase of 500 miles on a given date and possibly in a given location. Miles that are not used on the call date may either expire, may carry forward to another date or may be fully or partially reimbursed by the seller of the futures contract. Distance-based transportation futures may also include futures that have a defined origin point, but no explicit destination location beyond an agreed to a number of miles available for the contract, which allows the buyer to set the destination at a later point in time. Likewise, it is possible that transportation futures define a set destination point and number of miles so that the buyer is able to set the origin location at a later point in time. All types of transportation futures may define quality and quantity characteristics in that they may allow for conditions that may include, but are not limited to, the definition of freight conditions, security conditions, handling conditions, operating conditions or climate conditions.

The types of future storage or service capacity that may be traded include, but are not limited to, time-based, performance-based or location-based futures. For time-based storage futures, a specific date or date range is defined when materials are stored. Location-based storage futures specify the storage of materials in a specific location or geographic area and performance-based storage futures specify an end result such as the availability of materials in a specific location, in a specific condition or at a specific time. It is possible that storage futures include elements of all three types e.g. that a fulfillment partner takes possession of a material on a specific date or over a date range, that the materials are stored in a specific location or geographic area and that they are made available at a specific date or over a date range in a specific location and condition. For time-based service futures, a specific start or end time of service provision or a duration of service provision after the call date may be defined. Performance-based service futures define an end-result along with a start or completion date. Location-based service futures are provided in a specific location, for example a manufacturing facility of a buyer. It is possible that service futures include elements of all three types.

For the purposes of this invention disclosure, we often refer to transportation, storage or service futures as distinct products. However, it is possible that access to future transportation, storage or service capacity may be bundled into a single futures contract. For example, it may be possible that a future includes a first leg of transportation from one point to another where the materials are stored in a warehouse and where a kitting operation takes place and then they are transported further through a second transportation transaction to a third point. In this example, four single future contracts may be bundled into a single future.

For the purposes of this invention disclosure, we often refer to or imply that transportation, storage or service capacity is limited to one or multiple transportation, warehouse or services assets such as one or more trucks, one or more trailers, and so on. However, futures may be structured in ways that allow the resale of parts of the capacity covered by a given future. For example, a transportation, storage or service provider may sell the use of a single transportation asset such as a 40-foot dry trailer, which may be purchased by a buyer who only needs one third of the available space on the trailer. It is further possible that the seller only sells one third of the capacity on his trailer to the buyer in their futures contract and then proceeds to sell the additional capacity in one or more separate futures. It is also possible that the buyer purchases all of the available capacity on the trailer to then sell the remaining capacity through futures contracts of his own.

A special class of futures exists for transportation providers on return or backhaul drives. Today, carriers seldom have two loads, one to a destination and another back to the origin, under contract when they proceed to fulfill a transportation commitment. Much more prevalent is the case that the carrier travels from point A, which is his home base, to point B where freight is delivered and then needs to return empty. Going home empty is expensive and carriers often try to find loads for this backhaul segment of their trip. It is possible that carriers can sell backhaul capacity in a futures market long before they begin to execute the transaction assuming that they know where they will be when they take on a backhaul futures contract. However, a seller of a future may also decide to first sell a backhaul future contract to then proceed to find a forward haul transaction to get to that destination later. Naturally, it is possible that the forward haul is sold in one future and the backhaul on another. It is also possible that future for forward haul (from A to B) and backhaul (from B to A) may be combined into a single future that may be sold to one or more than one party. It is further possible that two parties may become joint buyers of a single future including a forward haul and back haul segment.

It is possible that transportation capacity may be offered through semi-autonomous or fully autonomous vehicles including, but not limited to, autonomous transportation vehicles or vans, autonomous cargo or delivery drones, or autonomous passenger vehicles in the future, which allow for around-the-clock vehicle operations, higher efficiency and lower operating cost. Futures executed for autonomous vehicles may often work in the same manner as those executed for driver-operated ones. Likewise, it is possible that future storage capacity may be handled in robotic warehouses which may be semi-autonomous or fully autonomous. These futures may often be handled in the same manner as traditional, human-operated warehouses. Further, it may be possible to handle certain supply chain services such as call center operations or complex planning operations through semi-automated or fully automated technologies such as artificial intelligence systems rather than by human operators. These futures may often be handled in the same manner as traditional, people-centric services futures. It is further possible that the sale of futures which involve semi-autonomous or fully autonomous transport, storage or service assets may be automated in that computer systems may determine free capacity for these assets and offer it on a trading platform where it is sold to one or more buyers.

It is possible that all of the tasks described throughout this invention disclosure may be performed by computer systems instead of human operators. In this manner, a seller may be a computing system controlled and operated by the seller organization or on behalf of the seller organization while a buyer may well be a computing system controlled and operated by the buyer organization or on behalf of the buyer organization. Especially as computing technology, data processing and analysis, or artificial intelligence evolve, it is likely that futures markets and trading platforms become semi-automated or even autonomous at some point in the future.

The parties involved in the fulfillment of a futures contract often do not know each other and may not have heard of each other prior to the purchase and sale of a future. This situation may well be characterized by a lack of trust on all sides. To establish reliable performance measures, transportation, storage and service capacity providers may need to be able to demonstrate how well they have executed on past futures among other criteria. This requires two components: on one hand, capacity providers need to be objectively monitored so that there is no way to “cheat” the system and, on the other, the performance results from monitoring the execution of a futures contract need to be recorded in a reliable manner, for example by writing them to an immutable ledger such as a distributed ledger, including, but not limited to, a Blockchain or Hashgraph, at the time of the contract execution and based on reliable evidence from the field.

The monitoring of futures execution may be achieved through a supply chain event management system, which may, or may not, record transaction execution details on a distributed ledger. Alternatively, execution monitoring may be handled by a third party that has access to all relevant documents and event recordings for a specific transaction and can provide a meaningful and reliable evaluation of the transaction execution that ranges from “was the carrier on time” to “did they document all stages of the transaction in a log or supply chain event management system”. The advantages that distributed ledger technology offers in recording transaction execution data include, but are not limited to, that transaction data may be accessible to more parties than those immediately involved in its execution, that all data may be recorded on an immutable ledger, which may be cryptographically more secure than databases or that all parties involved in the execution of the transaction may behave more truthfully when they know their actions are fully documented. It is also possible for third parties such as financial and insurance businesses to audit past futures performance before deciding on how much risk is involved in a given transaction between a specific buyer and seller.

Metrics on supply chain cost, time, quality or flexibility that describe the performance of capacity providers in detail may be collected through automated systems or manual user input. For the purposes of defining the performance of a party in a future, these types of metrics are applicable. Examples of these metrics include, but are not limited to, on-time performance, in-full freight delivery ratios, freight damage instances or ratios, dollar amount of damages over a time period, average vehicle speed, number of futures handled over time, number of defaults from futures, price per mile, price per pallet, price per square foot, price averages in past futures, number of futures executed successfully, number of futures offered, equipment condition and age, past and current insurance coverage, past and current insurance premiums, warehouse efficiency, asset utilization, past route efficiency, range of services offered, number of locations covered, financial stability of business or complaint ratios for past transactions. All metrics may be compared to those of other participants in futures contracts as well as to industry averages.

### BRIEF DESCRIPTION OF DRAWINGS

FIG. 1 is a diagram illustrating a classification of types of futures and providing practical examples;

FIG. 2 is a diagram illustrating mechanisms for pricing of futures;

FIG. 3 is a diagram illustrating a classification for different types of contingencies for defaults on futures;

FIG. 4 is a block diagram of one embodiment of a method for trading of fulfillment futures using buyer or seller pricing mechanisms;

FIG. 5 is a block diagram of one embodiment of a method for the resale of a futures contract from one buyer to another before a call date;

FIG. 6 is block diagram of one embodiment of a method for the resale of partial capacity on a futures contract by the buyer of the contract;

FIG. 7 is a block diagram of one embodiment of a method for the consolidation of multiple transactions into a single futures contract;

FIG. 8 is a block diagram of one embodiment of a method for the establishment of insurance risk of a futures contract;

FIG. 9 is a block diagram of one embodiment of a method for the factoring of a futures contract;

FIG. 10 is a block diagram of one embodiment of a method for the planning, sale and monitoring of a series of futures contracts executed by an autonomous vehicle;

FIG. 11 is a schematic of a system for supply chain event management for the monitoring of the execution of a future in accordance with an exemplary embodiment;

FIG. 12 is a block diagram of one embodiment of a method for the storage of a hashed event on a distributed ledger; and

FIG. 13 is a schematic of a system for a futures trading platform in accordance with another exemplary embodiment.

### DETAILED DESCRIPTION OF EMBODIMENTS

Methods and systems for the creation, validation and trading of transportation, storage or service capacity through future financial instruments (“futures”), the use of explicit legal futures agreements, the application of insurance contracts to futures, the application of factoring or another form of financing to pay for futures at the time of purchase or fulfillment, the monitoring of futures contract execution or the establishment of futures default contingencies. From here on after, financial and legal instruments that represent an option or contract for the fulfillment of future transportation, warehouse storage or service capacity use and that allow the trading of these instruments will be referred to as “futures” for the purposes of this invention disclosure.

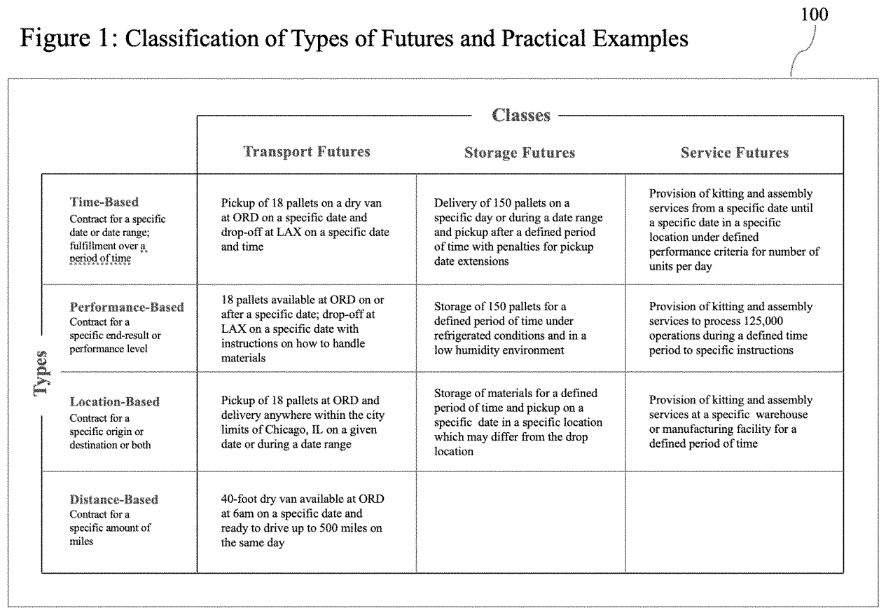

Referring to FIG. 1, a classification of different classes and types of futures is shown along with practical examples. Classification 100 comprises three classes of futures and four types of futures. Futures classes include, but are not limited to, the provision of transportation services, warehousing storage or supply chain services. Transportation services comprise of the movement of materials from one point to another considering specific factors that include, but are not limited to, the handling of materials, the securing of materials on a transportation asset, maintaining a certain temperature range, the avoidance of shock or harsh acceleration and deceleration, or taking a certain route to transport the materials. Warehouse storage comprises of the storing of materials considering specific factors including, but not limited to, storage temperatures, securing of materials in a physical location, restricting access to materials, counting of materials, or collecting and providing of data about the storage of materials under certain conditions. Supply chain services comprise of the provision of services including, but not limited to, call center operations, information technology provision, demand or supply chain planning services, maintenance and repair work, resource and staff augmentation, supply chain outsourcing services, kitting and assembly services, packaging or repackaging, contract manufacturing services, freight brokerage, freight forwarding, or dispatch services.

Futures types include, but are not limited to time-based, performance-based, location-based or distance-based. Specific examples of how each futures type applies to each futures class are provided in FIG. 1.

Time-based transportation futures define the day and time, or date range, for the execution of a transportation contract in the future. This may include an origin and destination location and a day and time, or date range, for pickup and delivery. Performance-based transportation futures define the end result of a transaction such as the delivery of materials from an origin to a destination location at a specific date or date range with the end-result in focus. These futures describe what needs to be have been accomplished at the end of the transaction under certain conditions. Location-based transportation futures define a specific service location for transportation providers such as a zip code, zip code range, a metropolitan area or one or more states for the operation of one or more transportation assets. Distance-based transportation futures define a number of miles as the core element of the contract which a transportation provider has to deliver on a call date. For example, a future might be defined as the purchase of 500 miles on a given date or possibly in a given location. Miles that are not used on the call date may either expire, may carry forward to another date or may be fully or partially reimbursed by the seller of the futures contract. Distance-based transportation futures may also include futures that have a defined origin point, but no explicit destination location beyond an agreed to number of miles available for the contract, which allows the buyer to set the destination at a later point in time. Likewise, it is possible that transportation futures define a set destination point and number of miles so that the buyer is able to set the origin location at a later point in time. All types of transportation futures may define quality and quantity characteristics in that they may allow for conditions that may include, but are not limited to, the definition of freight conditions, security conditions, handling conditions, operating conditions or climate conditions.

The types of storage or service futures that may be traded include, but is not limited to, time-based, performance-based or location-based futures. For time-based storage futures, a specific date or date range is defined when materials are stored. Location-based storage futures specify the storage of materials in a specific location or geographic area and performance-based storage futures specify an end result such as the availability of materials in a specific location, in a specific condition or at a specific time. It is possible that storage futures include elements of all three types e.g. that a fulfillment partner takes possession of a material on a specific date or over a date range, that the materials are stored in a specific location or geographic area and that they are made available at a specific date or over a date range in a specific location and condition. For time-based service futures, a specific start or end time of service provision or a duration of service provision after the call date may be defined. Performance-based service futures define an end-result along with a start or completion date. Location-based service futures are provided in a specific location, for example a manufacturing facility of a buyer.

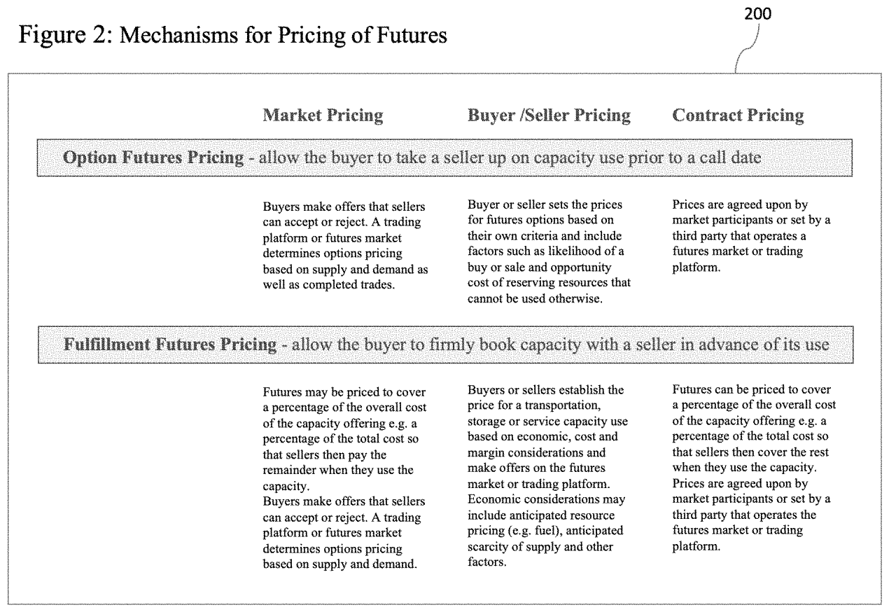

Referring to FIG. 2, a classification is shown comprising of mechanisms for pricing of futures. Classification 200 comprises of three mechanisms for pricing futures: market pricing, buyer or seller pricing, or contract pricing, and two implementations of futures: option futures or fulfillment futures. The main difference between option futures and fulfillment futures is that option futures only commit a seller to provide services while fulfillment futures commit both parties, the seller and the buyer, to the execution of the futures contract.

Option futures allow a buyer to take advantage of fulfillment of a transportation, storage or service contract from the seller at a price established when the option future was purchased. Option futures allow a buyer to lock in a price and specific conditions for a call date or date range when the option future turns into an executable transaction. In one embodiment of the present invention, option futures may have a price that is typically a fraction of the later fulfillment cost to the buyer, who may pay the agreed upon price for the execution of a transaction later. The seller commits to providing the transportation, storage or service capacity to the buyer at the agreed upon cost and under agreed upon conditions on a specific date or date range. The buyer may elect to let a call date pass without taking advantage of the capacity offered in the future. In another embodiment of the present invention, option futures may be defined so that the actual cost of fulfillment is left open and may be set based on economic factors or resource cost at the time of the call date. In this implementation of an option future, the buyer only locks in the availability of transport, storage or service capacity, but not the price of the later fulfillment. In yet another embodiment of the present invention, an option future may be priced by an algorithm or system.

Fulfillment futures allow a buyer to lock in a committed transportation, storage or service capacity at an agreed upon price, under specific conditions, on a specific date or date range or for a specific location or geographical area. In one embodiment of the present invention, the price of a fulfillment future may cover the full cost of the transaction. In another embodiment of the present invention, the fulfillment future price may cover a part of the full cost of the transaction such as a percentage of the total cost, which is usually paid when the buyer purchases the fulfillment option while the remainder of the transaction cost is due upon successful execution of the transaction and based on its terms of payment. In yet another embodiment of the present invention, the buyer may only pay the cost of the fulfillment option after the execution of the transaction. In a further embodiment of the present invention, it is possible that a buyer may pay a small fraction of the cost upfront and the majority of it later.

Option futures may be priced at a nominal price that only covers the purchase of the option, which may be a fraction of the actual transaction cost for the provision of transportation, storage or service capacity since the seller commits to holding the necessary resources at the ready when the option is either converted at an agreed upon price or alternatively expires. The decision whether or not to realize the option future and take the seller up on the provision of capacity is usually made in advance of the call date of the option future and defined as part of the contractual agreement. In some case, option futures may be purchased with the firm intention of executing the respective transaction so that the option future itself is mainly used to lock in a specific price and specific conditions by the buyer. For sellers, the actual cost of selling an option future is either an opportunity cost of not having planned an alternative use for the committed resources or it is the risk of higher input factor cost when the option future is called for option futures that have a committed price for fulfillment. Sellers may use option futures to wager on future economic conditions when they commit to a firm fulfillment price. One advantage of option futures is that the seller is able to capture the option future price which is an additional profit when the option future is taken up by the buyer while market conditions and resource cost have not changed substantially or have actually declined. Likewise, the price of the option future is a profit to the seller when the buyer does not take up the seller on the fulfillment and the seller is able to use the capacity elsewhere. In some embodiments of the present invention, the option future price may be partially or fully refunded when a buyer takes up the option of executing a transaction.

Fulfillment futures provide both parties in a transaction with the security of knowing that a specific transaction may be executed at a future point in time. Advantages to the seller include, but are not limited to, that sellers do not need to worry about selling the capacity otherwise while they have greater planning stability and they capture a percentage of the eventual revenues from the sale of transportation, storage or service capacity provision well in advance of the actual transaction execution. Advantages to the buyer include, but are not limited to, that buyers know they have available capacity when they believe they need it and they, too, have a higher planning stability. In some embodiments of the present invention, fulfillment futures allow buyers to lock in a specific price for transactions under specific conditions while in other embodiments of the present invention, fulfillment futures may leave the actual transaction cost open and subject to later agreement at or before the time of execution. In the latter cases, prices for the actual capacity provision may be tied to specific conditions in the futures contract such as fuel prices or an industry average for cost per mile in the case of transportation futures or to similar metrics for storage and service futures.

On futures markets or trading platforms that operate under market pricing, sellers establish prices at which they are willing to sell a futures contract and buyers establish prices at which they are willing to buy a futures contract. As soon as buyer and seller match, trades may be executed manually or automatically. The prices for option or fulfillment futures will gravitate towards consensus over time since sellers and buyers quickly develop realistic expectations about which prices can or cannot be achieved in the market. However, since the offerings are based on transportation, storage and service capacity, it is possible that very high seller prices may be acceptable to buyers as a futures contract offer nears its expiration or a possible call date. For example, if a shipper needs capacity to transport freight from point A to point B, they may not have a choice but accept a very high price a few days before the transport transaction since they will face the possibility of not moving the materials in question at all.

A buyer or seller pricing mechanism allows sellers to post the price of a futures contract in a futures market or on a trading platform while it allows potential buyers of a futures contract to respond with a purchase or counteroffers for the purchase of the futures contract. When option or fulfillment futures are traded under seller or buyer pricing mechanisms, either a buyer or a seller may take the first step of posting demand or, respectively, supply on a futures market or trading platform. The respective other side then has the ability to weigh whether the offer is good enough or should be countered. If it is countered, the party which posted the offering has the ability to either accept the counteroffer or respond with a new counteroffer and so on. The process repeats until an agreement has been reached or until at least one party understands that they cannot come to terms. In futures markets or trading platforms with hundreds or thousands of buyers and sellers, there may be as many or more different offerings as there are market participants. The difference between seller or buyer pricing and market pricing is that the former is based on a negotiation and there are fewer mechanisms for the future market or trading platform to establish prices automatically.

A third mechanism is contract pricing in which an option or fulfillment future price is set and does not necessarily change based on short-term supply and demand or based on a negotiation. In some embodiments of the present invention, contract pricing for option and fulfillment futures may be set by an independent third-party. In other embodiments of the present invention, contract pricing may be tied to metrics including, but not limited to, cost per mile in a given industry and for a specific service such as the use of 40-foot dry vans. In still other embodiments of the present invention, contract pricing may be based on a percentage of the cost of a transportation, storage or service capacity provision.

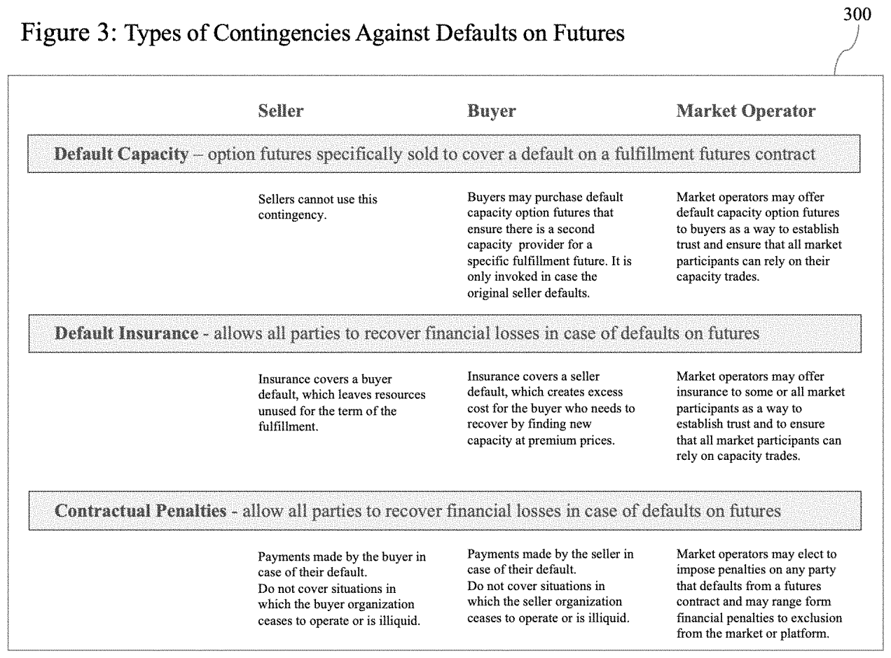

Referring to FIG. 3, a classification is shown comprising of three contingencies against futures contract defaults. Classification 300 comprises of three parties involved in a futures market or trading platform: sellers, buyers and market operators, and three contingencies against futures defaults: default capacity, default insurance and contractual penalties. Contingencies against buyer defaults mainly apply to fulfillment futures in that option futures will simply expire without being used, unless there are cases where the buyer does not pay for the option future itself or had previously committed to fulfillment of the option future.

Default capacity option futures are specific contracts that can be traded to cover already existing futures contracts. They are a secondary option futures contract that is only invoked if seller of the primary option or fulfillment future defaults. In case of a default, the default capacity option future takes effect and the transportation, storage or service capacity is provided by the seller of the default capacity option future. In some embodiments of the present invention, default capacity option futures may be traded independently of the primary futures contract. In other embodiments of the present invention, default capacity option futures may be combined with primary option or fulfillment futures into a single trade. Sellers may elect to offer default capacity option futures in partnership with other sellers to instill trust amongst buyers or to avoid contractual penalties. However, default capacity option futures do not protect sellers from buyer defaults. In some embodiments of the present invention, futures market or trading platform operators may offer default capacity option futures to some or all market participants as a way to establish trust or ensure that all option and fulfillment futures are secured from default.

A second contingency against futures contract default is the sale and purchase of default insurance, which covers sellers and buyers against a default of the respective other party. When a buyer defaults, the seller is likely to incur a financial loss since they may not be able to resell the available capacity, especially when the default occurs close to or on a call date. The same is true when a seller defaults in that the purchase of available capacity might likely cost substantially more for the buyer than the initial price that was agreed to in the option or fulfillment future contract. In some embodiments of the present invention, insurance against defaults and the additional incurred cost may be offered by independent insurance brokers or agencies or by other market participants. In other embodiments of the present invention, futures default insurance may be offered by the buyer or seller of a futures contract. In still other embodiments of the present invention, market operators may also elect to offer insurance against defaults to some or all parties in a futures market or on a trading platform.

A third contingency against futures defaults by either sellers or buyers are contractual penalties that may be defined in futures contract agreements. One advantage of this contingency is that buyers and sellers do not need to purchase default protection in the form of a second option future or insurance which needs to be procured at an additional cost. A disadvantage is that when the defaulting party is illiquid or ceases to exist as a legal entity, there is little or no protection for the surviving party of the futures contract. While contractual penalties are not available to market operators, who are not party to the contracts between buyers and sellers, the operator of a futures market or trading platform may elect to impose their own penalties that range from financial penalties to exclusion of defaulting parties from the futures market or trading platform.

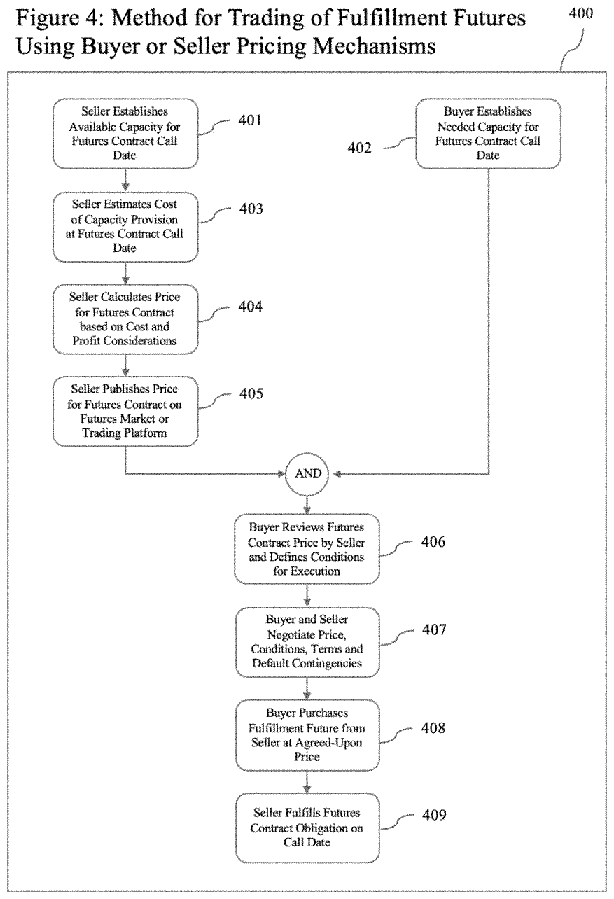

Referring to FIG. 4, shown is a block diagram 400 comprising a flow to illustrate a typical futures contract trade leveraging buyer and seller pricing mechanisms. Block diagram 400 comprises of nine steps to identify supply and demand for transportation, storage or service capacity, establish buyer and seller price expectations, negotiate an agreement and execute a transaction.

In block diagram 400, the process of trading transportation, storage or service capacity begins with a seller who establishes available capacity for a future date (401) such as “in three months” while buyers may establish the need for future capacity (402) “in three months”. The seller establishes the cost of capacity provision by taking the anticipation of factors that may include, but are not limited to, resource prices, general capacity availability and economic trends into consideration (403). Sellers may also take risk factors including, but not limited to, the likelihood of errors in the anticipation of cost conditions, the likelihood of buyer defaults or the opportunity cost of not securing a better price for available capacity at later points into consideration when they add a profit margin to the anticipated cost to establish a futures contract price (404). The seller then publishes the price for this futures contract on a futures market or trading platform where buyers can see it (405). A potential buyer, having identified a need for the future capacity, can now evaluate the price based on his own calculations of demand for future capacity taking factors that include, but are not limited to, the likelihood of resource cost increases until the call date, the likelihood that capacity availability increases until the call date or financial savings that stem from having planning stability into consideration (406). Once the buyer establishes the need for an offered futures contract, he may approach the seller to define specific conditions, terms and default contingencies to reach a mutually agreed-upon price for the futures option (407). The buyer purchases the futures contract from the seller (408) and the seller then executes the transaction accordingly (409).

A practical example of the process shown in block diagram 400 may be the provision of a transportation service from Houston, Tex. to Chicago, Ill. in three months from now for refined oil that needs to be moved on a tanker truck. Desirable conditions for the provision of transport capacity may include that drivers need to be specifically trained for oil and gas transport, that the truck and driver are certified to transport hazardous material, that the driver uses a specific route which avoids low overpasses and accident-prone areas or that the driver submits to stringent track and trace monitoring while he is progressing on the route. In his future contract pricing considerations, the seller may take these special conditions into consideration and also weight how hard it will be to secure return freight for the tanker truck from Chicago, Ill. to his home base in Houston, Tex. He may set the price at $3 per mile for this specific route and then offer the capacity to potential buyers on a futures market or trading platform. When making decisions about the purchase of tanker truck futures for hazardous materials, potential buyers can weigh the experience of the seller, their ability to execute or their history of past transactions among other factors to determine whether the offering is worth further consideration. In cases where it is, the buyer may engage the seller to negotiate a specific date and time for pickup and delivery taking into consideration that the truck needs to safely complete a near 1,100-mile trip, that the driver needs frequent rest stops and that there may be more opportunities to secure backhaul freight in Chicago, Ill. than in many other destinations that the seller might end up in. A potential buyer may then counter the seller offer with $2.75 per mile based on these considerations and offer to keep the pickup and delivery dates somewhat flexible as a concession in return. If there is sufficient trust and a desire to lock down the transport capacity three months in advance, the buyer and seller will eventually agree on a price and execute the transaction accordingly.

Not shown in block diagram 400 are cases where sellers offer capacity only for a certain amount of time e.g. a day or a few hours for sale on a futures market or trading platform. Further not shown in block diagram 400 is the situation where a buyer publishes demand for future capacity on a futures market or trading platform, which may then be taken up by a seller to offer specific futures to fulfill that capacity. Still further not shown in block diagram 400 are market pricing or contract pricing mechanisms. Further not shown in block diagram 400 is the negotiation and inclusion of futures default contingencies. Further not shown in block diagram 400 are cases where sellers offer future capacity on short notice, which may be the case when buyers default or when buyers elect to not execute their rights to fulfillment of an option future. Further not shown in block diagram 400 is the possibility to document parts or all of the steps on a distributed ledger. Still further not shown in block diagram 400 is the possibility that the transaction may be executed by a semi-autonomous or autonomous transportation asset.

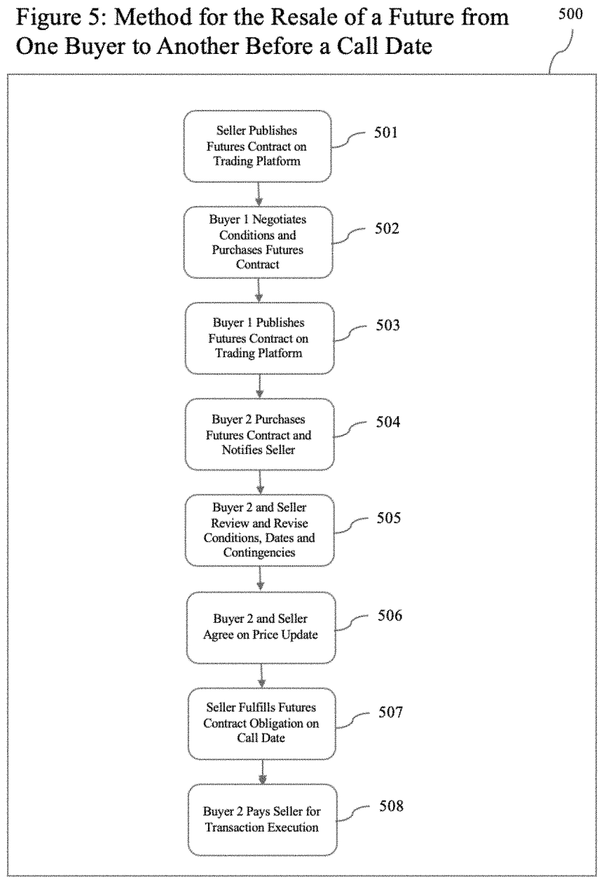

Referring to FIG. 5, shown is a block diagram 500 comprising a flow to illustrate the resale of a future from one buyer to another buyer before a call date. Block diagram 500 comprises of eight steps to sell a future from an initial buyer to a second buyer and to coordinate adjustments to the initially defined conditions with the original seller.

In block diagram 500, the process of reselling a transportation, storage or service future begins with a regular transaction in which a seller publishes available capacity for a future contract (501), which is negotiated and purchased by a first buyer from the seller (502). In cases, among others, where the first buyer determines that he does not require the purchased capacity any longer or where the initial buyer is merely speculating on rising futures prices before a call date, the initial buyer may publish the future contract for sale again on a futures market or trading platform (503). A second buyer can now purchase the future contract from the first buyer at a premium or at a discount (504) depending on the specific circumstances of the trade. The second buyer then contacts the seller to notify him of the change in ownership for the futures contract and to potentially negotiate a change in conditions (505) such as different days for pickup and delivery, different requirements for handling and securing freight or different expectations for the monitoring of freight in transit. If there are changes, then it may become necessary for the second buyer and seller to also renegotiate and agree upon a new price for the entire transaction (506). This may not change the price of an option or fulfillment future, but it may affect the remaining payment to the seller. The seller then fulfills his obligations under the futures contract (507) and completes the transaction as it was defined with the second buyer. The second buyer then pays the seller for the execution of the transaction (508) to conclude the process.

Not shown in block diagram 500 are situations in which the second buyer may just be a speculator or a financial business, both of whom would take on the option for different reasons, but neither of whom would likely ask for the actual delivery of capacity provision. Further not shown in block diagram 500 is the situation where a first buyer may be a speculator or financial business while the second buyer is an actual user of the capacity defined in the futures contract. Further not shown in block diagram 500 is how the different pricing mechanisms, default contingencies or financing options may affect the process. Further not shown in block diagram 500 are cases where the first buyer negotiates a wide range of conditions in order to make it easier for a second buyer to adopt the futures contract to their requirements. Further not shown in block diagram 500 are situations in which the first and second buyer both negotiate with the seller. Further not shown in block diagram 500 are situations in which there is more than one seller e.g. a second seller purchases the future from a first seller in order to fulfill the future. Further not shown in block diagram 500 is the possibility to document parts or all of the steps on a distributed ledger. Still further not shown in block diagram 500 is the possibility that the transaction may be executed by a semi-autonomous or autonomous transportation asset.

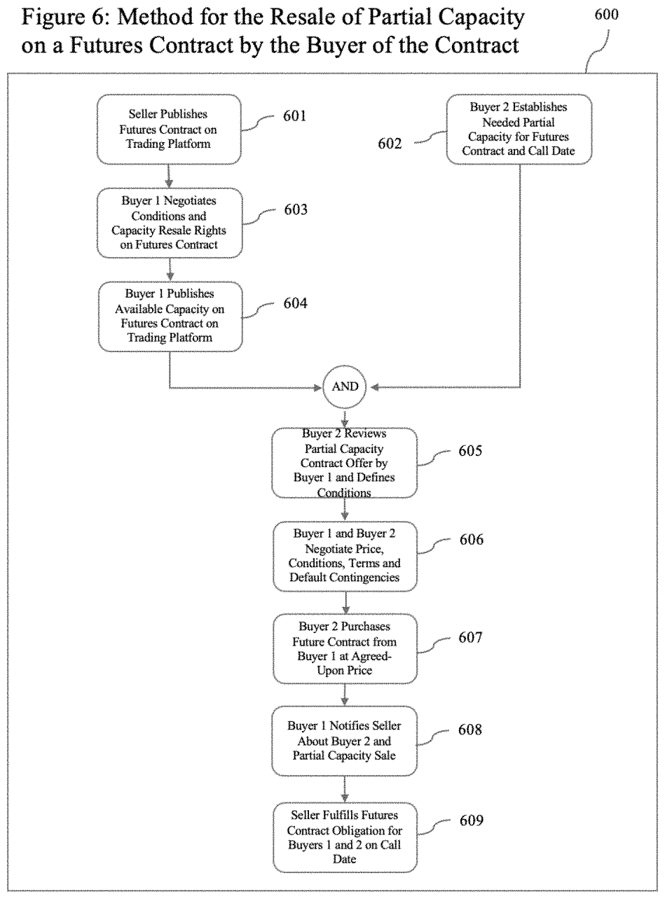

Referring to FIG. 6, shown is a block diagram 600 comprising a flow to illustrate the resale of partial capacity on a futures contract from one buyer to another buyer before a call date. Block diagram 600 comprises of nine steps to sell partial capacity on a futures contract from a first buyer to a second buyer and to notify the original seller of the sale of partial capacity. A practical example may be that a seller offers a full truckload futures contract for one 40-foot dry van on the futures market or trading platform while a first buyer only requires six of eighteen available pallet spaces on the trailer. Rather than let the remaining available space go unused, the first buyer may now sell his own futures contracts to fill up the remaining capacity. This case may be attractive to buyers who want to retain control over the entire shipment and defined conditions or may want to profit from the resale of capacity as they may be able to offset part of their own cost through profits achieved by the resale of remaining capacity at higher prices.

In block diagram 600, the process begins when a seller publishes a transportation, storage or service futures contract on the futures market or trading platform (601) while a first buyer establishes the need for partial capacity. In parallel, a second buyer establishes a need for partial capacity on a transportation asset on a specific date or date range (602). The first buyer negotiates the conditions such as the price, date or date range or default contingencies for the future and obtains the capacity resale rights for the futures contract from the seller (603). The first buyer publishes the remaining transportation capacity as a new futures contract on the futures market or trading platform (604), where the second buyer reviews it (605) and then negotiates price, conditions, terms and default contingencies with the first buyer (606). In some embodiments of the present invention, it may be possible to change certain conditions such as the date or date range of the original futures contract with the seller and in other embodiments of the present invention, the second buyer may simply accept the specific conditions stated in the futures contract between the seller and first buyer. The second buyer purchases the new futures contract for partial transportation capacity from the first buyer (607), who in turn notifies the seller of the second buyer and their agreed upon conditions (608). In some embodiments of the present invention, any additional cost that arises from the inclusion of a second buyer for the seller may have been covered in the first futures contract between the seller and first buyer already while in other embodiments the first buyer may reimburse the seller for additional cost that arises from the inclusion of a second buyer. Often the additional cost to the seller is likely included when the first buyer negotiates the resale rights of the futures contract with the seller. The process completes when the seller executes the transaction for the first and second buyer (609). The second buyer now pays the first buyer for the transport of partial capacity and the first buyer pays the seller for the entire transaction.

Not shown in block diagram 600 is the case where there are more than two buyers of remaining capacity on a transportation asset. In some embodiments of the present invention, the first buyer may resell remaining capacity on a futures contract to a second, third, fourth and so on buyer. In other embodiments of the present invention, a first buyer may resell all of the remaining capacity to a second buyer, who may then resell still remaining capacity to third, fourth and so on buyers. Further not shown in block diagram 600 is the case where the seller posts two or more futures contracts for his available capacity after selling a part of his capacity to a first buyer. In this instance, the seller will likely offer fulfillment conditions that are flexible so that a renegotiation with previous buyers of partial capacity can be avoided. If he doesn't, it may become necessary for the seller to renegotiate conditions and fulfillment dates or date ranges with all previous buyers of partial capacity. Further not shown in block diagram 600 is a sequence of future capacity offerings by the seller in which he sells a first partial capacity in a transportation asset, then posts the remaining capacity on the futures market or trading platform under the same conditions in a second futures contract, then sells another part of the capacity and posts a third futures contract for the still remaining capacity under the same conditions and so on. Further not shown in block diagram 600 are cases where storage or service futures contracts are resold, which occurs in the same way as the resale of partial transportation capacity on futures contracts. Further not shown in block diagram 600 is the possibility to document parts or all of the steps on a distributed ledger. Still further not shown in block diagram 600 is the possibility that the transaction may be executed by semi-autonomous or autonomous transportation, storage or service assets.

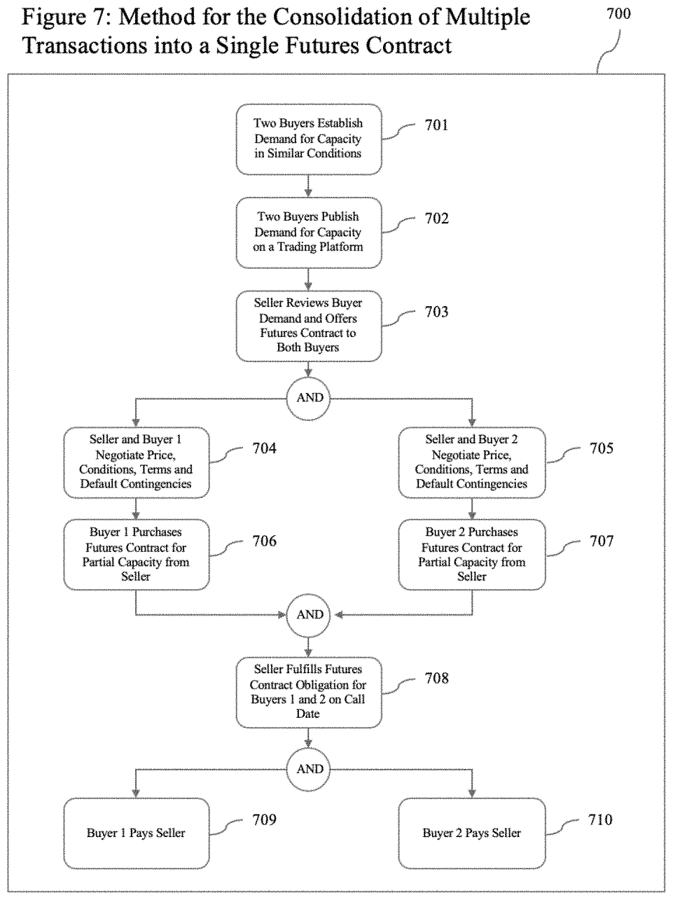

Referring to FIG. 7, shown is a block diagram 700 comprising a flow to illustrate the consolidation of future capacity demand into a single futures contract by a seller. Block diagram 700 comprises of ten steps in which two buyers publish demand for capacity on a futures market or trading platform and in which seller offers capacity to fulfill both demands in one or more related transactions. In a futures market or on a trading platform, sellers and buyers may publish offers for future transportation, storage or service capacity. When buyers publish their demand for future capacity, they may not always need an entire transportation asset, warehouse storage space or services capability, but rather just a part of it. For example, transportation buyers may only need part of a transportation asset such as a truck, trailer, railcar or ocean container. When they publish this demand, sellers may well combine several such demands to fill a single or multiple transportation assets that they may provide. Specifically, a first buyer may need partial capacity on a transportation asset such as a truck going from point A to point B on a given day or date range under specific conditions and a second buyer may have a very similar demand for partial transportation capacity from points A to B on the same or a close-by date or during the same date range under similar conditions. Sellers may elect to offer futures contracts prior to their sale to both buyers to fulfill their demand using the same transportation capacity. The flow in block diagram 700 differs from the flow in block diagram 600 in that in the former the use of a transportation asset is established prior to the sale of a futures contract while in the latter, the use of capacity is optimized after the sale of the futures contract.

In block diagram 700, the process begins when two or more buyers establish their need for specific future capacity (701), which they publish in a futures market or trading platform (702). Sellers participating in the same futures market or on the same trading platform can review both buyer publications and create specific future capacity offerings that cater to both buyers at the same time (703). The seller then contacts a first buyer to negotiate a futures contract taking price, dates, conditions, terms and default contingencies into consideration (704). The seller repeats this process with a second buyer (705). The first buyer purchases the futures contract from the seller (706) and so does the second buyer (707). The seller then fulfills his obligations to both buyers by executing the transaction (708). The process concludes when the first buyer pays the seller (709) and so does the second buyer (710).

Not shown in block diagram 700 are cases where demand from more than two buyers is consolidated into a single transaction eventually executed by the seller. Further not shown in block diagram 700 are cases where the seller consolidates demand from two or more buyers into a single futures contract, which then becomes a multi-party contractual agreement. Further not shown in block diagram 700 are cases where a seller publishes partial capacity in a futures market or on a trading platform first to solicit responses from multiple buyers. Further not shown in block diagram 700 is the possibility to document parts or all of the steps on a distributed ledger. Still further not shown in block diagram 700 is the possibility that the transaction may be executed by a semi-autonomous or autonomous transportation asset. Still further not shown in block diagram 700 are cases where storage or service capacity is traded in a similar way.

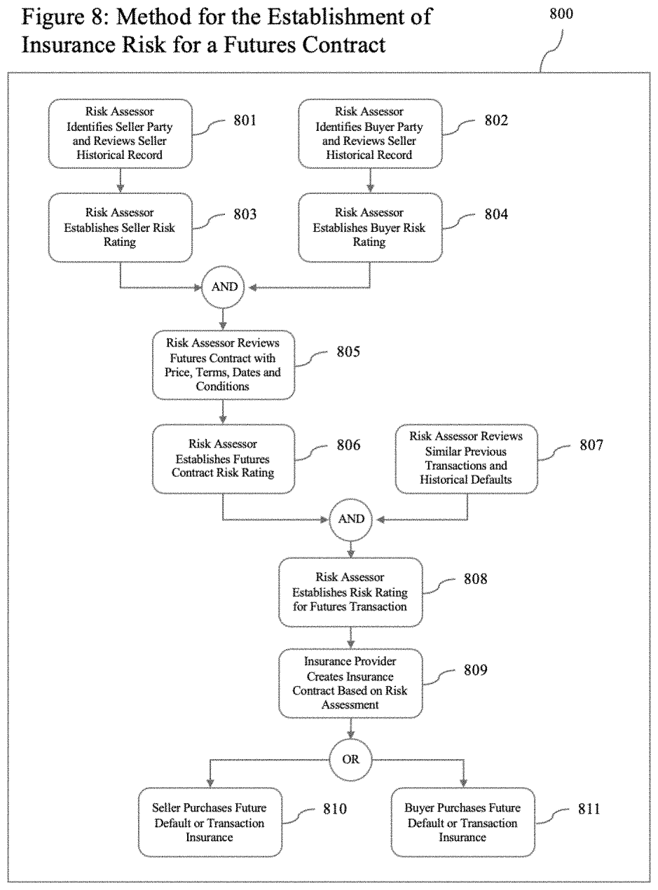

Referring to FIG. 8, shown is a block diagram 800 comprising a flow to illustrate the establishment of insurance risk for a futures contact. Block diagram 800 comprises of eleven steps in which a risk assessor weights different risk factors including, but not limited to, risk posed by the buyer, risk posed by the seller, risk posed by the transaction and risk posed by the future itself and in which an insurance provider offers insurance to cover a future. Insurance for futures may cover defaults as outlined in classification 300, but also the fulfillment of a transaction itself. Insurance providers may operate as part of a futures market or trading platform or they may be called upon by a buyer or seller before a future is executed.

In block diagram 800, the process begins when a risk assessor identifies the selling party (801) and the buying party (802) to review fundamental data about each that may include, but is not limited to historical transaction records, prior defaults on futures contracts, financial viability, business size, or business longevity. The risk assessor then establishes a risk rating for the seller (803) and buyer (804). Following, the risk assessor reviews the futures contract with its transaction details such as price, date or date range, fulfillment conditions and terms (805) to establish a risk rating for the futures contract (806). In some embodiments of the present invention, the risk assessor may also look at past similar transactions, historical records, statistics and analytics to establish prior risk and default conditions (807). The risk assessor may then establish a risk rating for the future transaction (808), which the insurance provider uses to create an insurance offering and contract for the future default or transaction execution (809). Finally, the seller may purchase the insurance (810) or the buyer may purchase the insurance (811), or both may do so (810, 811).

Not shown in block diagram 800 are parties other than insurance providers, which may offer default contingency insurance including, but not limited to, the buyer, seller or futures market operator as well as other third parties such as banks or factoring providers. Further not shown in block diagram 800 are a multitude of individual risk factors that include, but are not limited to, traffic conditions, weather conditions, extreme weather conditions, labor and labor union conditions, other force majeure factors, individual operator characteristics, or equipment and facility related factors. Further not shown in block diagram 800 are cases where multiple insurers collaborate to establish insurance products. Further not shown in block diagram 800 are cases where a computer system, algorithm or artificial intelligence system establish risk and create insurance contracts partially or fully automatically. Further not shown in block diagram 800 is the possibility to document parts or all of the steps on a distributed ledger. Still further not shown in block diagram 800 is the possibility that the transaction may be executed by semi-autonomous or autonomous transportation, storage or service assets.

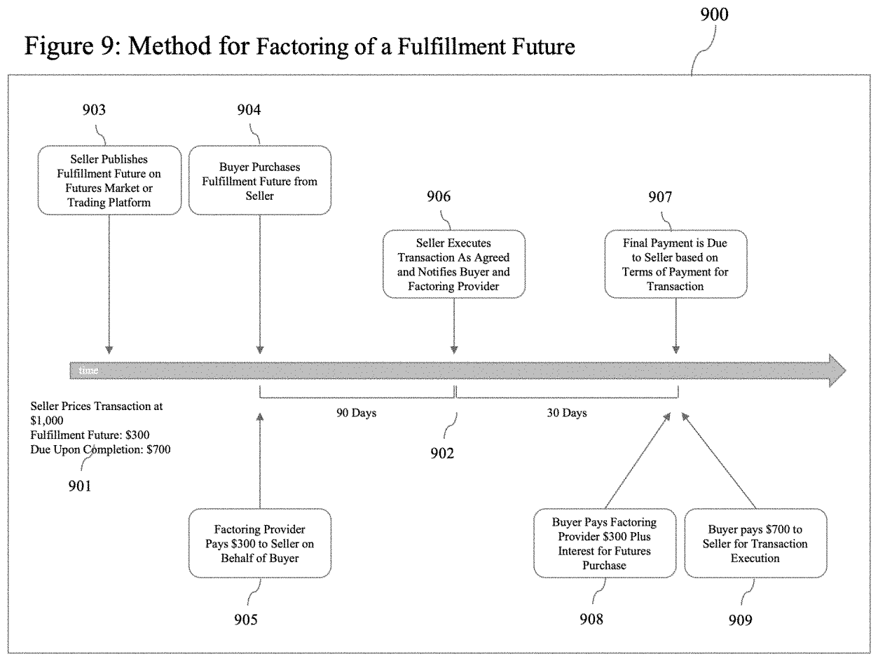

Referring to FIG. 9, shown is a block diagram 900 comprising a flow to illustrate the factoring of a fulfillment future. Block diagram 900 comprises of nine steps in which a buyer purchases a futures contract, a factoring provider pays for the futures contract and the buyer then pays the factoring provider and the seller at an agreed-upon time for the futures contract and fulfillment. Factoring is a process by which a third-party pays a transportation, storage or service provider upon completion of a transaction and, in parallel, assumes responsibility for accounts receivables from the paying party thus bridging the time between the execution of a transaction and its payment.

In block diagram 900, the conditions of the sale of a futures contract (901) are that a buyer purchases a fulfillment future for $1,000 where the future itself is priced at $300 and the actual fulfillment at $700. The terms of the contract include that the future is purchased 90 days prior to fulfillment and the second and final payment is due 30 days after successful completion (902). The process begins when a seller publishes a fulfillment future on a futures market or trading platform (903), which is purchased by a buyer (904). Instead of the buyer paying for the fulfillment future, a factoring provider now pays $300 to the seller for the future (905). The seller executes the transaction and notifies all parties (906). When the final payment is due to the seller 30 days later (907), the buyer pays the $300 plus an interest for the purchase of the fulfillment future to the factoring provider (908) and he also pays the remaining $700 for the actual fulfillment to the seller (909).

Not shown in block diagram 900 are case where a factoring provider also pays the seller for the fulfillment at the point when the transaction concludes successfully so that seller and buyer both benefit from factoring. Further not shown in block diagram 900 is the case where the seller is also a factoring provider. Further not shown in block diagram 900 are cases where the buyer pays the factoring provider before payment is due to the seller. Further not shown in block diagram 900 are cases where the buyer leverages another form of financing. Further not shown in block diagram 900 is the possibility to document parts or all of the steps on a distributed ledger. Still further not shown in block diagram 900 is the possibility that the transaction may be executed by a semi-autonomous or autonomous transportation asset.

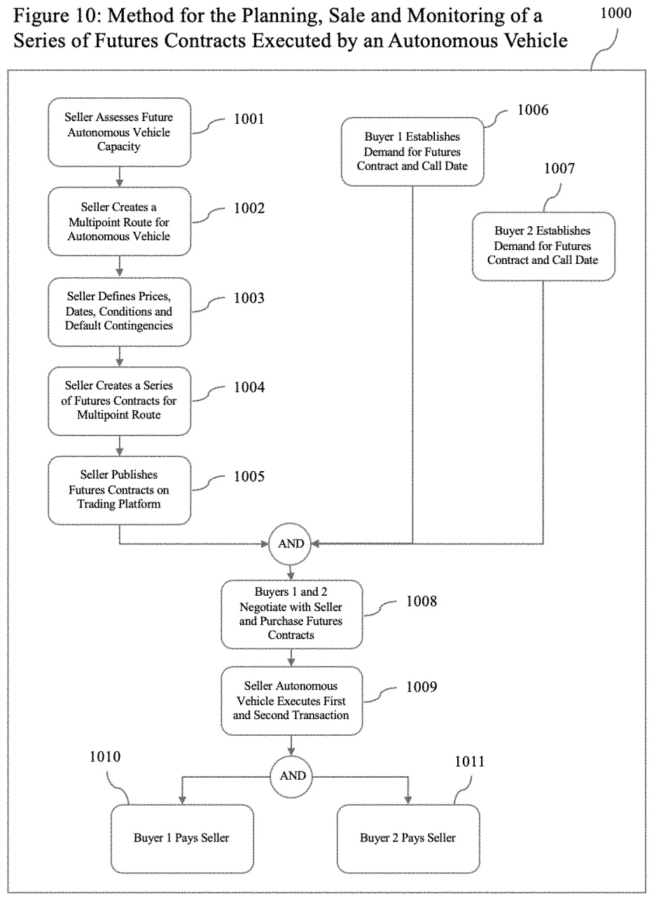

Referring to FIG. 10, shown is a block diagram 1000 comprising a flow to illustrate the creation of a series of futures contracts for an autonomous or semi-autonomous vehicle. Block diagram 1000 comprises of eleven steps to plan for a series of transport transactions performed by autonomous or semi-autonomous vehicles that are published to a futures market or trading platform and then subsequently executed as a fulfillment transaction. Transportation may well see advances in autonomous or semi-autonomous vehicles to a point where they may eventually dominate over-the-road transportation. A futures market or trading platform is a valuable tool that allows for the automation of scheduling and trade of capacity for autonomous or semi-autonomous vehicle operations.

In block diagram 1000, the process begins with the seller of autonomous or semi-autonomous vehicle capacity assessing the availability of future transportation capacity (1001). Based on observations on a futures market or trading platform, heuristics, or past experiences, the seller may then identify a number of route points that are comprised of forward haul and back haul transactions or of a multipoint route e.g. from point A to point B to point C and back to point A. The seller may then combine these route points into a series of futures contracts (1002) and define prices, terms, conditions, dates and default contingencies for each (1003). Based on this work, the seller creates a series of futures contracts (1004), which he subsequently publishes on the futures market or trading platform (1005). In parallel, a first buyer may identify a demand for future transportation capacity that may correspond to one or more route segments the seller has published on the futures market or trading platform (1006). Similarly, a second buyer may identify a demand for future transportation capacity that may correspond to one or more route segments the seller has published on the futures market or trading platform (1007). The first and second buyer then negotiate with the seller and eventually purchase future contracts for autonomous or semi-autonomous vehicle capacity (1008). The autonomous or semi-autonomous vehicle controlled by the seller executes the transaction based on the agreed-upon conditions of the futures contract (1009). Finally, the first buyer pays the seller (1010) and the second buyer pays the seller (1011).

Not shown in block diagram 1000 is the ability to offer other robotic capacity including, but not limited to, autonomous forklifts and material handling equipment in warehouses, autonomous drone operations, or autonomous or robotic assembly machines. Further not shown in block diagram 1000 are semi-autonomous vehicles that still require the presence of a human operator, even when they operate autonomously for parts or all of a route. Further not shown in block diagram 1000 is the use of smaller autonomous or semi-autonomous vehicles used for last-mile deliveries, passenger transport or local material movement. Further not shown in block diagram 1000 is the ability of sellers to observe and aggregate future capacity demand based on requirements that buyers may publish on a futures market or trading platform. Still further not shown in block diagram 1000 is the ability of an automated computing system performing tasks that human sellers or buyers normally perform. Further not shown in block diagram 1000 is the possibility to document parts or all of the steps on a distributed ledger. Further not shown in block diagram 1000 are cases where a distributed ledger technology is used to automate parts or all of the steps shown in block diagram 1000 through smart contracts.

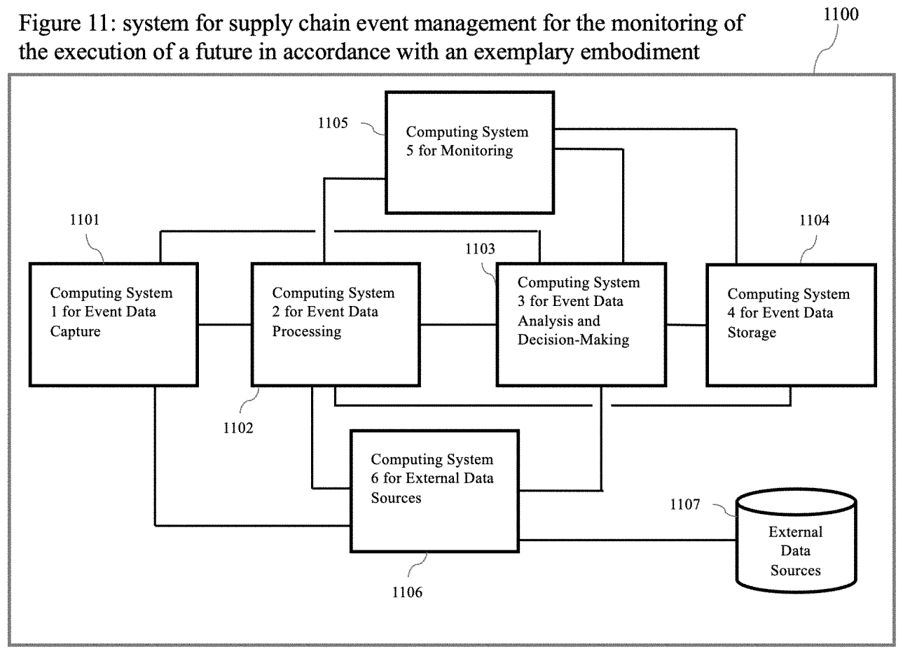

Referring to FIG. 11, one embodiment of the present invention comprising a system for monitoring of futures contract execution is shown. System 1100 comprises of six computing systems for the capture, formatting, processing, analysis, monitoring, sharing and storing of transaction event data that allows a buyer and seller of a futures contract to monitor its execution. The term “event data” describes the occurrence of a state. For the execution of a future, examples of event data may include, but are not limited to, the pickup of materials at an origin location, the position of a transportation vehicle on a route, the drop-off of materials at a destination location, or the capture of a signature from a receiving manager, conditions under storage, storage locations or process measurements during service provision. The application of system 1100 allows buyers and sellers to monitor transaction execution through the capture of event data that is then formatted, analyzed and processed before it is shared.

Event data may be captured on a first computing system (1101), then being sent to a second computing system (1102) for processing, then being sent to a third computing system (1103) for analysis and decision-making, then being sent to a fourth computing system (1104) for storage, a fifth computing system (1105) for monitoring other computing systems and a sixth computing system (1106) to access data on external systems or from external data sources (1107). A practical example is the transport of materials from point A to point B where the materials are delivered. Using system 1100, a vehicle operator may deliver materials to the destination warehouse at point B where he takes photos of the delivered freight on pallets and obtains a signature from a receiving manager confirming that all materials have been delivered correctly, that none were damaged and so on. System 1100 stores all of this evidence and allows buyers and sellers of a futures contract to monitor the capture of event data in near real-time. The resulting event data may then serve as proof of delivery and allow the seller to submit an invoice for any outstanding payments to the buyer, who in turn knows that he can pay the seller based on having successfully completed the transaction.

Not shown in system 1100 is the writing of event data to a distributed ledger including, but not limited to, a Blockchain or Hashgraph, in addition to storage in a fourth computing system (1104), which allows all parties to trust that information in the database has not been tampered with among other advantages. Further not shown in system 1100 are cases in which buyers and sellers each have their own system for the monitoring of transaction execution.

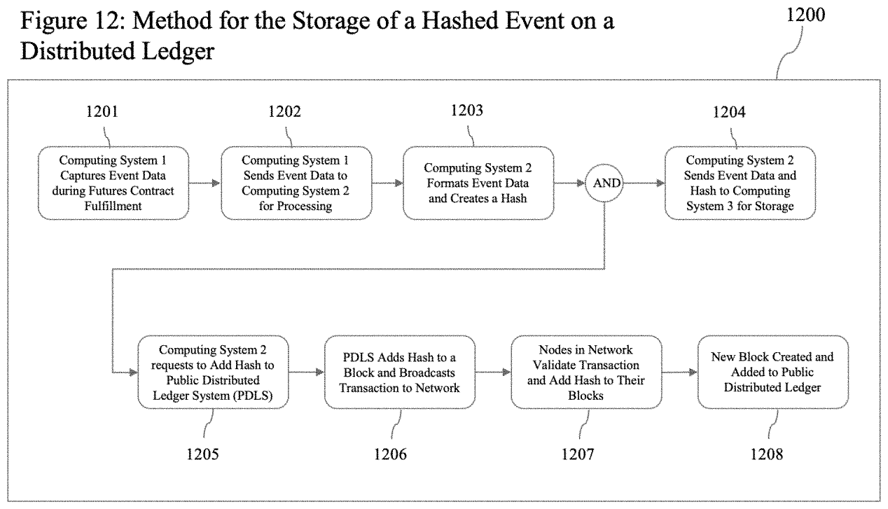

Referring to FIG. 12, shown is a block diagram 1200 comprising a flow to illustrate the writing of an event data hash to a public distributed ledger. Block diagram 1200 comprises of eight steps to capture, format, process, hash and store event data in regard to the execution of a futures contract and to store the hash on a public distributed ledger.

In block diagram 1200, the flow begins when a first computing system captures event data during the execution of a futures contract (1201). A first computing system sends the event data to a second computing system for processing (1202) where the event data is formatted, and a hash is created (1203). The second computing system then sends the formatted and processed event data and its hash to a third computing system for data storage (1204) and also sends the hash to a computing system comprising a public distributed ledger with a request to add the hash to the public distributed ledger (1205). The computing system comprising a public distributed ledger adds the hash to a block and broadcasts the transaction to a network of nodes (1206). The nodes in the network validate the transaction and add the hash to their blocks (1207). As a result, a new block is created and added to the public distributed ledger (1208).

Not shown in block diagram 1200 is the ability to write a hash to a private distributed ledger or a hybrid distributed ledger. Further not shown in block diagram 1200 is the ability to write whole event data rather than just a hash to a private, public or hybrid distributed ledger.

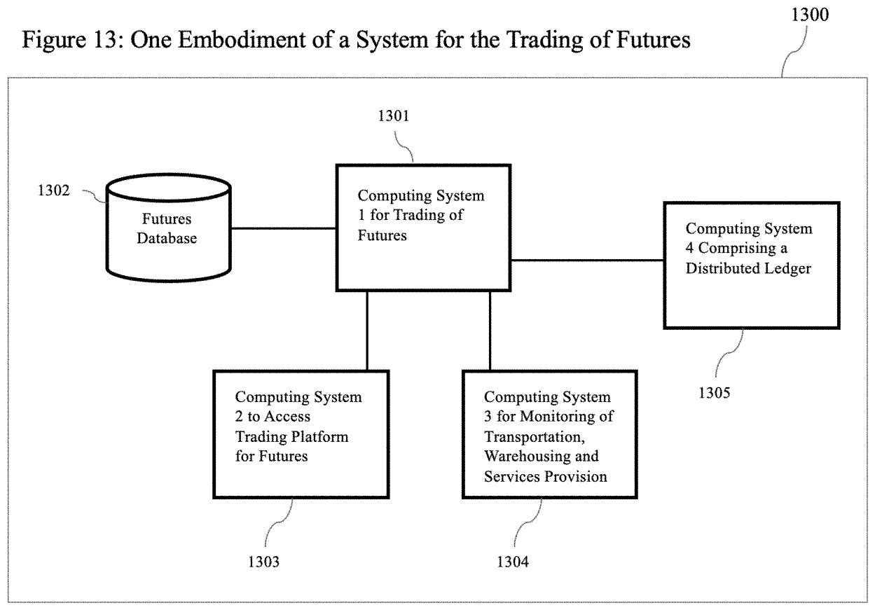

Referring to FIG. 13, one embodiment of the present invention comprising a system for trading of futures is shown. System 1300 comprises of four computing systems for the trading of futures, access to the trading system, the monitoring the futures execution and access to a distributed ledger that allow the trading of futures.

A futures market and trading platform (1301) stores all current and past futures in a database (1302) and may be accessed through a computer system used by participants in the futures market (1303). Not shown in system 1300, the trading platform (1301) may further access external data from a variety of sources. In one embodiment of the present invention, the trading platform may have direct access to a system that allows for the monitoring of the execution of a fulfillment transaction (1304) so that the completion of transactions may be recorded on the trading platform (1301) and written to its database (1302). Not shown in system 1300, each participant on the futures market may use their own system for monitoring of fulfillment transactions independently. In another embodiment of the present invention, the trading platform (1301) may further access a computing system comprising a distributed ledger (1305) to write parts of each transaction or all data about each transaction to a distributed ledger including, but not limited to, a Blockchain or Hashgraph. In other embodiments of the present invention, the trading platform (1301) may not write data to a distributed ledger.

The use of the term “or” in the claims is used to mean “and/or” unless explicitly indicated to refer to alternatives only or the alternatives are mutually exclusive, although the disclosure supports a definition that refers to only alternatives and to “and/or.” When used in conjunction with the word “comprising” or other open language in the claims, the words “a” and “an” denote “one or more,” unless specifically noted. The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to, possessing only those one or more steps and also covers other unlisted steps.

Unless indicated otherwise the steps in the methods disclosed herein can be performed in any order.

What is claimed is:

1. A method of trading a transport, storage or service future financial instrument, comprising:
a. a seller of the transport, storage or service futures financial instrument publishing a quote for the transport, storage or service futures financial instrument on a transport, storage or service futures trading platform;
b. a buyer of the transport, storage or service futures financial instrument reviewing the quote for the transport, storage or service futures financial instrument; and
c. the buyer of the transport, storage or service futures financial instrument ordering the transport, storage or service futures financial instrument.

2. The method of claim 1, wherein the buyer negotiates a different price of the transport, storage or futures financial instrument with the seller prior to ordering the transport, storage or futures financial instrument.

3. The method of claim 1, wherein the seller of the transport, storage or service futures financial instrument fulfills the transport, storage or service provided for in the transport, storage or service futures financial instrument.

4. The method of claim 1, wherein the pricing of the transport, storage or service futures financial instrument is determined by:
a. the buyer of the transport, storage or service futures financial instrument publishing a price for the transport, storage or service futures financial instrument on a transport, storage or service futures trading platform that a seller of the transport, storage or service futures financial instrument can accept or reject;
b. the buyer or seller of the transport, storage or service futures financial instrument publishing a price for the transport, storage or service futures financial instrument; or
c. the buyer and seller of the transport, storage or service futures financial instrument agreeing to the price of the transport, storage or service futures financial instrument.

5. The method of claim 1, wherein the transport, storage or service futures financial instrument includes:
a. a provision for a default capacity option futures financial instrument;
b. a default insurance provision; or
c. a contractual penalty provision.

6. The method of claim 5, wherein the price of the default capacity option futures financial instrument, the default insurance or the contractual penalty is based on an assessment of the risk of fulfillment of the transport, storage or service futures financial instrument.

7. The method of claim 1, wherein the transport, storage or service futures financial instrument is a transport futures financial instrument that provides for the use of a semi-autonomous or autonomous vehicle or drone.

8. The method of claim 1, wherein the transport, storage or service futures financial instrument is a storage or service futures financial instrument that provides for the use of a robotic, semi-autonomous, autonomous device, vehicle or drone.

9. The method of claim 1, wherein factoring or another form of financing is used to pay for the transport, storage or service futures financial instrument at the time of purchase or fulfillment of the transport, storage or service futures financial instrument.

10. The method of claim 1, wherein execution of the transport, storage or service futures financial instrument is monitored by a supply chain event management system.

11. The method of claim 9, wherein details of the execution of the transport, storage or service futures financial instrument are recorded on a distributed ledger.

12. The method of claim 1, wherein the buyer of the transport, storage or service futures financial instrument resells the transport, storage or service futures financial instrument to a second buyer before a call date of the transport, storage or service futures financial instrument.

13. The method of claim 1, wherein the buyer of the transport, storage or service futures financial instrument sells a portion of the transport, storage or service futures financial instrument to a second buyer before a call date of the transport, storage or service futures financial instrument.

14. The method of claim 1, wherein the transport, storage or service futures financial instrument is time-based, performance-based, location-based or distance-based.

15. The method of claim 1, wherein the quote for the transport, storage or service futures financial instrument is published jointly by a first seller and a second seller.

16. A system for trading transport, storage or service futures financial instruments, comprising: means for receiving and processing trading messages for transport, storage or service futures financial instruments, the trading messages comprising quote messages for transport, storage or service futures financial instruments and orders messages for transport, storage or service futures financial instruments transmitted electronically through an electronic communications network from computers geographically remote from the means for receiving and processing trading messages; wherein the electronic trading system further comprises a message queue through which quote messages and order messages pass when received by the means for receiving and processing trading messages from the geographically remote computers; the means for receiving and processing trading messages further comprising: storage means for electronically storing received quote messages and order messages; matching and execution means for matching received quote messages with received order messages and, upon the creation of a match, executing a trade based on the match.
